(19) United States
(12) Patent Application Publication
(10) Pub. No.: US 2022/0107208 A1
(43) Pub. Date: Apr. 7, 2022

(54) POSITION-MEASURING DEVICE FOR MEASURING AN ABSOLUTE POSITION

(71) Applicant: IC-HAUS GMBH, Bodenheim (DE)

(72) Inventors: Peter FISCHER, Bodenheim (DE); Manfred HERZ, Mainz (DE); Christian KÜLLER, Essenheim (DE); Christian WACHTER, Ober-Ramstadt (DE); Hartmut SCHERNER, Gau-Bischofsheim (DE)

(21) Appl. No.: 17/428,445

(22) PCT Filed: Feb. 11, 2020
(86) PCT No.: PCT/DE2020/100090

§ 371 Date: Aug. 4, 2021

(30) Foreign Application Priority Data
Feb. 12, 2019 (DE) 10 2019 103 465.5

(51) Int. Cl. G01D 5/347; G06K 7/14; G01D 5/249

(52) U.S. Cl. CPC G01D 5/34792; G01D 5/2495; G06K 7/1421

(57) ABSTRACT

A position-measuring device and a corresponding method for measuring an absolute position includes a material measure having a first binary code and a second binary code and a sensor device that scans the first and second binary codes. The sensor device scans the first binary code, which has a first number of code words, each having the same code word length. The second binary code of the material measure forms a portion of the first binary code and has a second number of the code words that can be mapped onto the first binary code.

### TECHNICAL FIELD

The present invention relates to a position-measuring device for measuring an absolute position with a measuring standard that has a binary code and a sensor device that scans the binary code, wherein the sensor device is designed to scan a first binary code that has a first number of code words that have the same code word length. The invention further relates to a corresponding method for measuring an absolute position with a position-measuring device.

### BACKGROUND

Various sensor principles are known for position measurement, such as, for example, optical or magnetic methods. Optical position-measuring devices are thus, for example, known in which the measuring standard is exposed to a light source and the light impinging on the measuring standard is modulated in accordance with a specific pattern. The measuring standard can consist for this purpose of regions with different reflectivities or of transparent and opaque regions. A transmitted light or reflection arrangement can be used. The modulated light can be detected by the sensor device and converted into a position signal. Magnetic position-measuring devices are also known in which the measuring standard comprises magnetic regions of different polarities. The magnetic fields detected when stationary and/or the magnetic field changes brought about by the movement of the measuring standard can then be detected by the sensor device such as, for example, Hall sensors. Largely sinusoidal and cosinusoidal sensor signals can be generated in this way, and can be evaluated, so providing information about the position of the component. Position-measuring devices of this type are known from, for example, DE 10 2011 050 834 A1 or DE 10 2014 112 459 A1.

Position-measuring devices can furthermore be designed either as linear position-measuring devices that capture linear movements and/or linear positions of the component, or as rotational position-measuring devices for capturing rotary movements and/or angular positions of the component. The measuring standard can have for this purpose a linear or radial scale of the measuring standard.

The code positions on the measuring standard can be encoded by means of a digital code such as, for example, a binary code, in which the individual regions of the measuring standard are each configured to correspond to one bit of the binary code, wherein the individual regions form, when joined together, the individual code words of a predefined code word length of the binary code.

Known position-measuring devices for determining the absolute position have measuring standard that comprise multiple position tracks arranged next to one another. In this case, the absolute position can be read out using multiple sensor elements arranged perpendicular to the direction of movement. It is, however, disadvantageous in these kinds of solutions that a large number of position tracks are needed for longer binary codes, and these must then be scanned in parallel over a comparatively large width of the measuring standard or, must lie accordingly close to one another, which can lead to crosstalk and to a lower alignment tolerance.

Alternatively, position-measuring devices are therefore known having measuring standard with single-track shift codes. In this case, the position information is encoded in a single position track with encoded regions arranged after one another in the direction of movement, and the information is read out by means of sensor elements arranged one after another in the direction of movement. A number of bits is then captured in the sensor region, and the binary code is displaced during movement relative to the sensor device, whereby the position of the bits within the code word each changes by 1, while one bit leaves the region captured by the sensor device on one side and another bit enters this region on the other side.

A further processing unit that can contain a code converter that performs conversion of the code into code positions with a fixed assignment can follow the sensor device.

The position-measuring devices described can also be the basis of the invention, and the invention can be used in this application. The various sensor principles can also be employed with this invention.

Such position-measuring devices have indeed been proven in use in the past. It has, however, been found disadvantageous that, in particular because of a fixed length of the sensor elements of the sensor device in the direction of movement and the length of the regions or of the bit sequences on the measuring standard thereby entailed, the respective sensor device can in each case only be used for a position-measuring device with one measuring standard of a specific size. For rotational position measurement devices this means that the radius on which the bit sequence must be located is also determined by the predefined length of a bit and the number of bits in the full binary code. If, for example, rotary measuring standard measures with a smaller or larger diameter should therefore be used, it is necessary to install an entirely new system, for example based on a changed sensor device on an integrated circuit, as the individual regions can otherwise no longer be correctly captured by the sensor device. If the length of a bit remains unchanged, and/or if the bit length on the sensor device is not adjusted to match that on the measuring standard, discontinuities, or in the worst case even non-unique code positions, can arise if two code positions with the same encoding exist.

An incremental encoder with an index track that has a binary encoding over one rotation, and therefore offers information about the absolute angle, is known from U.S. Pat. No. 5,998,784 A. This quasi-absolute scanning takes place serially, and requires a movement relative to the measuring standard. The selected binary code can be complete, or can be shortened for different measuring standard. The assignment of the code words of the shortened binary codes to position values takes place by means of a code conversion stored for the shortened code. The code conversion must therefore be re-implemented in advance each time for the respective measuring standard. It is not possible to use the same code conversion for different measuring standard.

### SUMMARY

Against this background, a position-measuring device is disclosed in which the size, in particular the diameter, of the measuring standard used can be adjusted, in particular with an unchanged code conversion, and that a secure and reliable readout of the binary code is nevertheless possible. The invention can be employed in position-measuring devices that are used in many areas of technology for capturing movements and/or positions of components, for example of a shaft or of a carriage. Either a measuring standard measure or a sensor device is arranged for this purpose at the component to be captured, so that the relative movement of the measuring standard with respect to the sensor device can be captured.

In corresponding position-measuring devices, the measuring standard is scanned by the sensor device, while the measuring standard is joined to the component to be measured and is designed in such a way that the sensor device can uniquely capture any position of the component to be measured, even, in particular, when stationary. The relative arrangement at the time in each case between the measuring standard and the sensor device is sufficient for measurement of the absolute position.

This object is achieved according to the invention with a position-measuring device in that the binary code of the measuring standard is a binary code that forms a portion of the first binary code with a second number of code words which can be mapped onto the first binary code. In particular here the binary code can be reproduced in the portion of the first binary code. The two binary codes can comprise unique code words, each of which is assigned to a unique code position with the code word length over which the binary codes extend.

By reproducing the second binary code as a portion of the first binary code, and in particular as a result of the specification of a fixed mapping relationship, the code positions derived from the second binary code can be uniquely assigned to the code words of the same code word length, and the same function blocks and position-measuring device elements can thus be used for further processing the second binary code as for the first binary code. It is thus no longer necessary that a completely new position-measuring device and/or sensor device is to be constructed for each application. Rather is it possible for the size of the measuring standard to be adapted as required to the respective application. A position-measuring device can be realized for different applications and components, in particular for measuring standard of different diameters. In particular, it is possible for only the measuring standard of the position-measuring device to be exchanged, while the sensor device and the further processing unit, together with the code conversion, can be retained. It is possible as a result of the mapping to use the same sensor device and further processing unit to scan different measuring standard.

It has been found to be particularly advantageous in this context if the second binary code can be mapped onto the first binary code by means of a predefined mapping rule. In this way, the measuring standard can be adapted in a simple manner to very different position-measuring device systems, and for the second binary code to be shortened in terms of the number of code words in comparison with the first binary code that has been chosen to be longer. It has been found particularly advantageous if the mapping rule is formed of a scaling or transformation rule.

The mapping of the binary codes can be done by mapping the code positions that are permanently assigned to the individual code words of the two binary codes. It can be possible to map the code positions of the second binary code onto the code positions of the first binary code, in particular by means of a mapping rule. This can be represented as follows:

Pₘ→P_{M}

The mapping can particularly preferably take place using a formula that links Pₘ mathematically with a function f:

Pₘ·f(M,m,P_{S})=P_{M}

P_{M} here represents the ascertained position of the first binary code onto which the ascertained position Pₘ to which the second binary code can be mapped, M is the first number of code words of the first binary codes having the same code word length, m is the second number of the code words of the second binary code having the same code word length, and P_{S} is the start position of the second binary code within the first binary code. A start value S can here also be assigned to the start position. The code positions P_{M}, Pₘ and P_{S} on the measuring standard can be defined here as an angle (in °, degrees) in the case of rotary systems and as a distance (in mm) in linear systems. Other dimensions of the position are also possible.

The following relationship to the assigned code number CN_{M} can apply here for P_{M}:

P_{M}=CN_{M}×360°/M

In the shortened code space with m code positions with the code numbers CNₘ, each of which is assigned to the code position Pₘ on the reduced measuring standard, the following accordingly applies for the code position Pₘ:

Pₘ=CNₘ×360°/m.

A scaling and/or displacement can preferably be taken into account in the mapping. The function f can contain a scaling and/or displacement for this purpose. In simple words, the scaling can indicate here how much of the first trimmed binary code remains in the second code, and the displacement can indicate the position at which a part of the first binary code has been cut out.

The scaling can be specified by a scaling factor. The ratio between M and m can be taken into account by the scaling factor. The size ratio can be taken into account by means of the scaling, and this is reflected in a different numbers of code words, M and m. The scaling factor can establish the ratio between M and m. The scaling can, for example, be done with fewer code words C and thereby a smaller diameter of the measuring standard, proportional to m/M.

A displacement can particular arise because the portion that has been cut out is located at a suitable place in the first binary code, so that a closed binary code again arises. With respect to the smaller measuring standard, the start value S from the code space of the trimmed, first binary code can be set as the new zero position with CNₘ=0. This can have a displacement of the zero position as a result. The start position P_{S} of the trimmed, larger measuring standard that is assigned to the start value S, and thereby to the zero position, on the smaller measuring standard, can be described as follows:

P_{S}=S×360°/M

S, as the start value in the shortened code space of the second binary code, can thus be determined in the code space of the first binary code, whereby the start position P_{S} on the larger, trimmed measuring standard can be set into relationship with the zero position on the smaller measuring standard.

A position displacement does not take place if the start value is S=0. A displacement is therefore not necessary in every case.

The following mapping rule V can be used to describe the mapping relationship between P_{M} and Pₘ:

P_{M}=m/M*Pₘ+P_{S}

This mapping rule thus contains both a scaling expressed by m/M, and the displacement expressed by Pₛ.

The mapping can thus take place taking a scaling factor and/or a position displacement into account. The scaling factor can here establish the relationship between the first number of code words and the second number of code words (C).

The mapping rule V describes the mapping relationship between P_{M} and Pₘ. Since, in the practical application of the invention, Pₘ is the value to be ascertained, the mapping rule V can also be rearranged as follows:

Pₘ=(M/m)*(P_{M}−P_{S})

The mapping rule V preferably includes the fact that the first binary code with the code positions P_{M} assigned to them, from which the start position P_{S} of the second binary code can preferably be subtracted, can be mapped onto the value range of the second binary code through multiplication by a predefined factor, in particular the first number M of code words to the second number m of code words.

It is further preferred that the binary codes have unique code words that are each assigned to a unique code position within the code word length over which the binary codes extend. Through a unique sequencing of binary code words it is possible to ensure that reading the measuring standard by means of the sensor device can be done directly, without further measurement to ascertain the absolute position. When the measuring standard is displaced bit-by-bit with respect to the sensor device, a specific sequence of binary code words with a predetermined code word length can be generated in which each code word occurs only precisely once. Since each code word only occurs once, it follows that precisely one code position can be assigned to each code word. The code words of the first binary code and of the second binary code can preferably have the same code word length, in particular L bits. Code words with a code word length between five and 16 bits have been found particularly advantageous. The code word length can, however, here be chosen depending in particular on the number of code words.

It is furthermore advantageous if the code words remaining in the second binary code have the same sequence as the code words of the first binary code, in particular those in a portion thereof. A simple mapping, and thereby a transfer of the second binary code onto the first binary code, and thus a use of the sensor device designed for the first binary code, is in this way possible in a simple manner. A unique assignment can be ensured in this way.

It is furthermore advantageous if the measuring standard is designed with a single track and/or multiple tracks with at least one position track with binary position markings. The absolute position can thus be read out in a simple manner. The position markings can here preferably be formed from the encoded regions of the measuring standard and, in particular, from the reflecting and/or transmitting and/or polarizing regions of the measuring standard. Further tracks, such as an index track, a second, preferably also inverted, absolute track, an incremental track or the like can particularly preferably also be provided, so that the measuring standard can, in particular differentially and/or in the course of array sampling, be scanned, or divided more finely through interpolation

It is further proposed that the first binary code can be generated by means of a pseudo-random number generator. A pseudo-random bit sequence that repeats itself cyclically can be generated for this purpose, especially with a given start value. Binary codes of a maximum length can preferably be generated by means of suitable pseudo-random number generators. Every possible bit combination is generated in this case by the generator before repetition occurs. The existing hardware can be most effectively exploited by this. A pseudo-random distribution of the individual regions of the measuring standard can be generated in this way, in which the individual regions can correspond to the individual bits of the binary code. The individually encoded regions are here arranged one after another, so that a specific number of sequential regions of the measuring standard each form a code word that uniquely defines the absolute code position. When the measuring standard is displaced by a single bit, a new code word is already formed, and a sequence of different code words is available over the entire scope that is to be absolutely captured. A serial or sequential code of this sort is often referred to as a chain code or as a pseudo-random code.

A further embodiment provides a further processing unit for processing the scanned sensor signals further. The further processing unit can particularly preferably be designed in such a way that it can process these code position signals captured by means of the sensor device from different measuring standard. The further processing unit can, in particular, contain a function block that generates incremental signals. Commutation signals can, alternatively or additionally, also be generated. Further signals, such as, for example, incremental AB-signals, as a measure for the speed and/or direction of movement, can preferably be ascertained in the further processing unit from the ascertained code words and, in particular from the code positions ascertained from them. The further processing unit can be designed as a counter that forms a multi-turn value or, in linear systems, a multi-length value. The further processing unit can furthermore be an interface such as for example BiSS, SPI or the like.

According to an advantageous embodiment, the conversion of the scanned code words in the code space into positions takes place by means of a look-up table and/or by means of a shift register decoded for feedback. Alternatively or in addition other mathematical methods can also be used. The binary code ascertained by means of the sensor device can in this way be converted into a unique position independently of the position-measuring device used and/or of the measuring standard used. The position can thereby be ascertained and processed. The same function and/or circuit blocks can be used in this way for processing the second binary code as for the first binary code, and the conversion can in particular be performed in the further processing unit that follows the sensor device.

It is further advantageous if the first binary code with a first number of code words having the same code word length is a complete code. In the sense of the invention, a complete binary code can refer to codes in which all possible code words occur in the code space. A complete binary code can in particular be a code in which all possible M=2^{L} bit combinations occur, where M describes the first number of code words and L describes the code word length.

It is further preferred if the first and/or second binary code is a closed code, in which, on exceeding the last code word, in particular the last code position, the first code word, in particular the first code position, again follows. A closed code can, in particular, comprise sequential code words in which preceding or succeeding code words can be generated through a shift operation of 1 bit in each case. The code can preferably be cyclic. A corresponding closed binary code preferably does not exhibit a discontinuity, not even when returning to the beginning of the code from the end of the code. In the case of the second binary code, this behavior is essentially comparable to the behavior of the, in particular complete, first binary code, including at the beginning and end of the region with code words that have been omitted in comparison with the first binary code, and can therefore be handled with little effort in a comparable manner. Code discontinuities in the region of the complete second binary code can be avoided in this way.

From the point of view of construction, it is further proposed that the measuring standard is designed as a rotary measuring standard, in particular as a circular disk or roller. In this case, a mapping of a second binary code, in particular as an equivalent portion, onto the first binary code can take place in a simple manner, in particular if the binary code is designed as a closed code.

A further embodiment provides that for mapping the second binary code onto the first binary code, unique code positions are predefined through a start value and end value, or through the second number of code words m and the start value or end value of the second binary code within the first binary code in the further processing unit. In this way, a correlation between the two binary codes can be performed at the evaluating system in the further processing unit. The position output can, for example, thus be adjusted in such a way that code positions between 0 and M−1 are always output, where M represents the first number of code words of the first binary code. It is advantageous if the start position and end position are specified for the evaluation in order to restrict the searching and the run-on in this region, and to find the match with the binary code that is present just once.

It is sufficient if at least two of the three parameters
start value S within the first binary code,
end value E within the first binary code and/or
number m of the second code words
   are specified to the further processing unit to carry out the mapping for the respective measuring standard to be used. The number M of the first code words is in any event known to the further processing unit due to the stored code conversion, and can be stored there as a fixed value. The three values can be converted using the relationship m=M−(S−E−1).

It is further advantageous if the second binary code has a start position at the start address that can be subtracted from the current code position of the measuring standard to map the second binary code onto the first binary code. A correlation between the second binary code and the first binary code can thus be established in a simple manner, and a mapping achieved.

In a further embodiment of the invention, it is proposed that the sensor device comprises at least a variety of sensor elements, so that the total code word length L of a code word can be captured simultaneously or in sequence, in particularly partially or as a whole in sequence. The number of sensor elements can particularly preferably correspond to the code word length L. Depending on the particular application, the sensor elements can preferably be designed as photosensitive sensors, in particular as photodiodes, and/or as magnetic field sensors, in particular Hall sensors, by means of which the change modulated by the measuring standard can be measured particularly effectively and simply, and can be converted into a corresponding signal strength.

It is preferred if the position-measuring device is designed as a measuring or counting position-measuring device. When designed as a measuring system, a measurement can be taken to ascertain the position in which code positions are captured that are located within the binary code being used. The evaluation of the signals can preferably be carried out by the further processing unit, wherein the positions output can preferably be continuous over the complete binary code.

As a counting system, position-measuring devices are in particular indicated in which, following recognition of a code word or index signal, counting continues beyond these until a synchronization and/or check against a measured value again takes place. The code position ascertained by counting in the meantime during rotation or movement can, in the case of the second binary code, also however be located outside the code region in use. A correction can be performed by the further processing unit for this reason if necessary. On reaching the first separating point of the second binary code, the further processing unit can jump for this purpose to the second separating point of the second binary code, from where counting is continued.

In a method of the type mentioned at the beginning, the object is achieved in that the binary code of the measuring standard is a binary code that forms a portion of the first binary code with a second number of code words that are mapped onto the first binary code.

The advantages already described in connection with the position-measuring device result from this. All of the features of the position-measuring device can, individually or in combination, also be applied to the method according to the invention.

As already described, the two binary codes can in particular have unique code words that are each assigned to a unique code position with the code word length over which the binary codes extend.

The code positions of the second binary code can be mapped onto the code positions of the first binary code, in particular by means of a mapping rule (V). The mapping can take place taking a scaling factor and/or a position displacement into account. The scaling factor can establish the relationship between the first number M of code words and the second number m of code words.

### BRIEF DESCRIPTION OF THE DRAWINGS

Further details and advantages of the invention are to be explained in more detail below with reference to the exemplary embodiments shown in the drawings, in which:

FIG. 1a shows a position-measuring device with a measuring standard comprising a first binary code;

FIG. 1b shows a tabular illustration of an exemplary embodiment of a first binary code according to FIG. 1a;

FIG. 2 shows a measuring standard according to FIG. 1 that has been shortened by a predefined cut-out area, so that only a portion of the first binary code of FIG. 1a remains;

FIG. 3a shows a position-measuring device with a shortened measuring standard comprising a second binary code that forms a portion of the first binary code;

FIG. 3b shows a tabular illustration of an exemplary embodiment of a first binary code according to FIG. 3a;

FIG. 4 shows the arrangement according to FIG. 1a;

FIG. 5 shows the arrangement according to FIG. 2;

FIG. 6 shows the arrangement according to FIG. 3a; and

FIG. 7 shows a block diagram of a position-measuring device with a further processing unit.

### DETAILED DESCRIPTION

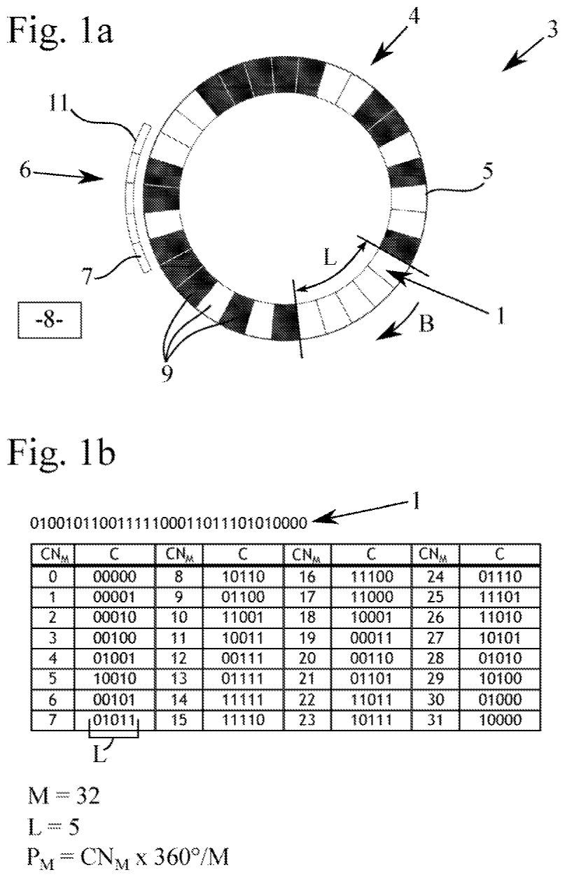

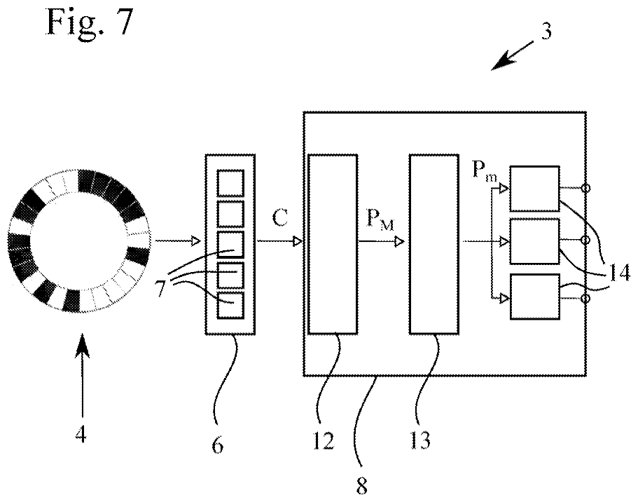

Parts of a position-measuring device 3 which can be used in very different technical fields to ascertain the absolute position of a component, not shown in more detail, are illustrated in FIGS. 1 to 3. The block diagram of a position-measuring device 3 with a division into function blocks is shown in FIG. 7.

The position-measuring device 3 can be embodied, as required, as an optical or as a magnetic position-measuring device 3. Such a position-measuring device 3 can comprise a measuring standard 4 as well as a sensor device 6. In the case of an optical position-measuring device 3, the measuring standard 4 can comprise differently reflective or light-transmitting regions 9, wherein the scale of the measuring standard 4 is illuminated by a light source, not illustrated. In the case of a magnetic position-measuring device 3, the scale of the measuring standard 4 comprises, on the other hand, magnetic position markings 9, that differ in their magnetization. Depending on the application, the measuring standard 4 can moreover comprise a linear or circular scale.

According to the present exemplary embodiment, the measuring standard 4 is designed as a rotary measuring standard 4. The measuring standard 4 comprises a position track 5 that comprises the encoded regions in the form of code position markings 9 that are designed in the manner of a binary code 1, 2, and which each correspond to one bit of the binary code 1, 2. The code position markings 9 can be scanned with the aid of the sensor device 6 and, in particular, by means of a variety of sensor elements 7. The capture of the movement of the code position marking 9 of the position track 5 supplies code positions that reproduce the change in the position. Depending on the application, multiple position tracks 5 can also be provided, such as for example a further, possibly inverted, absolute track, or also an index track or incremental track or the like, by means of which one or a plurality of index markings or increments can be scanned.

During the operation of the position-measuring device 3, the code position markings 9 of the position track 5 are moved in accordance with the present exemplary embodiment with a circular measuring standard 4, along a circular track with a radius around the axis of rotation in the direction of movement B, and are detected by the sensor elements 7 of the sensor device 6. The measuring standard 4 can preferably be designed for this purpose as a rotary measuring standard 4, in particular as a circular disk or roller. The measuring standard 4 can alternatively, for example, also be designed as a linear scale.

The code position markings 9 of the position track 5 of the measuring standard 4 are, in the present exemplary embodiment, designed as a binary code 1, 2. The binary code 1, 2 can, for example, be a pseudo-random code that can be generated by means of a pseudo-random number generator. With a predetermined start value S, an apparently random bit sequence, repeating itself cyclically, is generated in this way. The binary code 1, 2 is designed here in such a way that a new code word C is always generated in response to a displacement. There is no discontinuity even at the end of the closed binary code 1, 2, where the start value S begins again. The binary codes 1, 2 can in particular be designed as shift codes. This means that when displaced by one or a plurality of locations, a new, and again unique, code word C is generated.

In FIG. 1 the measuring standard 4 comprises a scale that is encoded with the first binary code 1. The first binary code 1 has a first number M of code words C, each of which has a predefined code word length L. The code word length L can be chosen according to need, and have an arbitrary number of bits, in particular N bits. According to the present exemplary embodiment, the code words C have a code word length L of five bits. The first number M of code words C is here selected to be 32, i.e. 2⁵ bits. Other configurations are, however, also conceivable, in which a different first number M of code words C and/or a different code word length L is chosen. With the aid of this binary code 1, all the code positions P_{M} can be uniquely specified, so that in particular all of the code positions assigned to the code numbers CN_{M} in code space, and thus the physical code positions P_{M}, in particular angle values, can be uniquely specified on the measuring standard 4. In particular, the binary code 1 used is a complete and/or closed binary code 1. A complete code 1 here is one in which all of the M=2^{L} bit combinations occur. A closed binary code 1, 2 does not have any discontinuities, not even from the end of the binary code 1, 2 to its freely definable beginning.

A discontinuity in the binary code 1, 2 would be defined here as a continuous change in the code positions P_{M}, Pₘ, not consisting of a single step, when the shift code is displaced by one bit. A binary code 1, 2 with a discontinuity allows the execution and evaluation according to the invention with restrictions and/or in portions of the bit sequence.

As can be seen in FIG. 1b, the first binary code 1 in the present case, in particular beginning with CN_{M}=0 and the code position P_{M}=0, comprises the following bit sequence: 01001 01100 11111 00011 01110 10100 00. With a code word length L=5, a total of M=32 code words C can be formed with this complete code 1, wherein the code words C can each be generated from the preceding code word C through shift operations of 1 bit in each case, and are unique. These code words C are correspondingly numbered in sequence in the table in FIG. 1b with the code numbers CN_{M}, and form the code space. As can also be seen in this table, a unique physical code position P_{M} (in degrees) on the measuring standard 4 with the code word length L spanned by the binary code 1, can also be assigned to each unique code word C. The respective code number CN_{M} in the table here corresponds to the code position P_{M}=CN_{M}×360°/M, wherein physical code position P_{M} is assigned to the last of the L bits in the clockwise sense of a code word C. In FIG. 1a and FIG. 1b the code word C 00000 with the code number CN_{M} 0 in the code space, and the physical code position P_{M}=0 have been chosen as the start position. The full angle of 360° corresponds, in linear systems, to the segment with the M code positions P_{M}.

These unique code positions P_{M} can now be read out by means of the sensor device 6 spatially assigned to the measuring standard 4. The position markings 9 can be scanned for this purpose by means of the sensor elements 2 of the sensor device 6. The sensor device 6 comprises, according to the present exemplary embodiment, five sensor elements 7 that are arranged next to one another in the radial direction. In the present case this corresponds to the code word length L. The invention is not, however, restricted to this. Rather, further configurations are conceivable in which more or fewer sensor elements 7 are provided. It is particularly preferable for the sensor device 6 to have at least a variety of sensor elements 7, so that the total code word length L of a code word C can be captured simultaneously or in sequence, in particularly partially or as a whole in sequence.

The sensor elements 7 each have essentially the same length and are arranged—apart from a technical minimum distance—on a sensor track 11. The length of the sensor elements 7 is preferably adjusted to the length of the position markings 9 of the position track 5 of the measuring standard 4. The position-measuring device 3 thus has sensor elements 7 of a fixed size for capturing the digital values, whereby the length of a code position marking 9, and thereby of one bit, is predefined (within certain limits). The assignment of the binary code 1, 2 to the position cannot be changed, so that the position-measuring device 3 is designed to capture a measuring standard 4 with the complete binary code 1.

For rotational position-measuring devices 3 this means that the radius on which the bit sequence must be located is also determined by the predefined length of a bit 9 and the fixed number of bits 9 in the full binary code 1. If a smaller radius is now to be used, the length of the bits 9 in a complete binary code 1 would become smaller, as a result of which this can no longer be captured correctly by the sensor elements 7, in particular of a given sensor device 6. If, on the other hand, the length of the sensor elements 7 and the length of a bit 9 matched to that on the measuring standard remain unchanged, only a portion of the binary code 1 can be used. According to the invention the possibility is prevented that when code words C are omitted, bit combinations are read out that are indeed present in the complete binary code 1, but are not located at the correct position, and thereby code position within the remaining used region, or are even located within the excluded region. The code positions captured by the sensor elements 7 would otherwise, for example, be non-continuous or even not unique if two code positions with the same encoding were to exist.

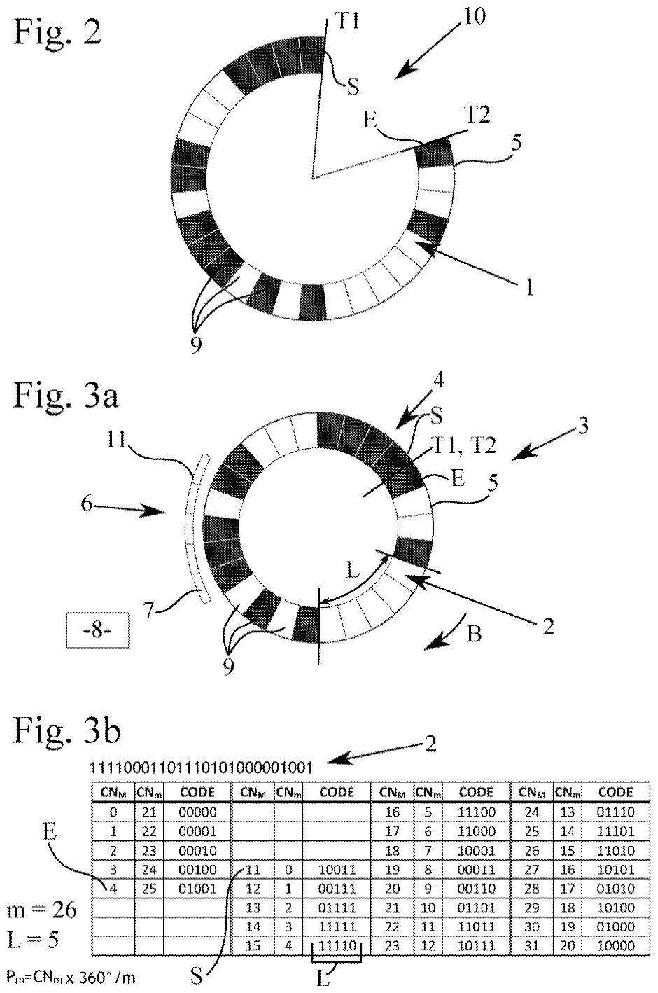

In order now to realize the possibility of being able to deal with a position-measuring device 3 with different measuring standard 4, and in particular different measuring standard 4 with different diameters, by means of an in particular predefined system 3, in which the length of the position markings 9 remains the same, the binary code 1 can be adjusted in such a way that on a smaller measuring standard 4 the binary code 2 is a binary code 2 forming a portion of the first binary code 1, with a second number m of code words C that can be mapped onto the first binary code 1. In this way, a particular portion of the first binary code 1 can be omitted, and a unique code position assignment can nevertheless be achieved. The illustration in FIG. 2 shows by way of example such a binary code 1 of a first measuring standard 4 designed for a number M of code words C with a missing portion 10, wherein this code 1 has separation points T1, T2.

This shortened code 1 can then be transferred to a second measuring standard 4, in particular of a smaller design, as is shown by way of example in FIG. 3a. The second binary code 2 can in particular then be joined at the separation points T1, T2. As can be seen for example in FIG. 2 and FIG. 3b, a part of the code words C has been removed from the binary code 1; compare, for example, the code words C with the code numbers CN_{M} 5 to 10. In this way, the same scanner can be used for measuring standard 4 with different diameters.

The second binary code 2, which represents a partial code of the first binary code 1, is no longer complete, but is also closed in itself, and also, as a shift code, has no discontinuities. This behavior corresponds largely to the behavior of the first binary code 1, and can therefore be treated in a similar manner with little effort in the further processing unit 8.

According to the invention, the second binary code 2 can be mapped onto the first binary code 1, in particular by means of a predefined mapping rule.

The mapping is done in such a way that the code positions Pₘ of the second binary code 2 can be mapped onto the code positions P_{M} of the first binary code 1. The mapping rule here gives the mapping relationship between Pₘ and P_{M}.

The mapping rule V can, for example, be described by means of the formula

P_{M}=(m/M)*Pₘ+P_{S}

or

Pₘ=(M/m)*(P_{M}−P_{S})

in the same way. The mapping relationship between Pₘ and P_{M} is fixed and unique, so that by means of the specified mapping rule both Pₘ can be mapped onto P_{M} and P_{M} can also be mapped onto Pₘ. In the initial generation of the second binary code 2 for the respective measuring standard with m<M, the omitted portion of the first binary code 1 is selected in such a way that this results in a fixed and unique mapping relationship. The respective mappings can then be calculated by means of the mapping rule V.

The mapping rule V contains a scaling using a scaling factor and a position displacement. This is necessary, as some of the positions of the large code disk 4 with M positions are missing when capturing the smaller code disk 4 with m positions. The further processing unit 8, however, preferably expects all the positions of the large code disk 4, while the size relationship must at the same time be given consideration. This is achieved by the mapping.

The second binary code 2 also comprises unique code words C, each of which is assigned to a unique code position Pₘ with the code word length L over which the binary codes 1, 2 extend. The code words C of the second binary code 2 here have the same sequence as the code words C of the first binary code 1, with the code words C omitted with respect to binary code 1. The second binary code 2 enables continuous position values, and, as a shift code that is still closed, has no discontinuities. Binary code 2 begins with the code number CN_{M} 11 from the binary code 1 for the start value S with a new code number CNₘ=0, and ends with code number CN_{M} 4 from the complete binary code 1 at the end position E with the new code number CNₘ=25.

The mapping rule referred to above thus corresponds to a displacement, in particular by a position Pₛ, of the code positions Pₘ corresponding to the code words C of the binary code 2, and scaling by multiplication of the physical code positions P, in particular as angular values of the binary code, by the factor M/m or m/M.

The respective code number CNₘ in the table in FIG. 3b corresponds here to the code position Pₘ=CNₘ×360°/m.

The code numbers CNₘ extend from 0 to 25, taking into account the overflow with respect to code numbers CNₘ of the complete binary code 1 from CN_{M}=31 to CN_{M}=0.

The table of FIG. 3b, in which the values of CN_{M} are listet, serves above all for a better understanding of the background to the invention. In the practical realization of the invention, the table according to FIG. 3b does not have to be stored in the sensor device, since the calculation of the position Pₘ is done by the code conversion illustrated in FIG. 1b, with subsequent mapping.

As is shown by the exemplary embodiment of FIGS. 3a and 3b with a measuring standard 4 with a scale with a second binary code 2, the second binary code 2 has, according to the present exemplary embodiment, the following bit sequence: 11110 00110 11101 01000 00100 1. This bit sequence is recorded at the code start value S with movement of the measuring standard 4 in the clockwise direction. With a code word length L=5 remaining the same, a total of m=26 unique code words C can be formed with this code 2. As can be seen in the table in FIG. 3b, a unique physical code position Pₘ with the code word length L spanned by the binary code 2, can thus also be assigned to each unique code word C.

To map the second binary code 2 onto the first binary code 1, the start value S and the second number m of code words C, or the start value S and the end value E, or the end value E and the second number m of code words C can, for example, be specified. A unique mapping of the second binary code 2 onto the first binary code 1, and thereby a usability of further components of the position-measuring device 3, in particular of the sensor elements 7 on the sensor track 11 and the further processing unit 8, can be achieved in this way. The second binary code 2 can, in particular, have a start position P_{S} that can be subtracted from the respective code position P_{M}, in particular as an angular value, to map the second binary code 2 onto the first binary code 1.

According to the table in FIG. 3b, the code number CNₘ=11 corresponds, for example, to the angular value P_{M}=CN_{M}×360°/M=11×360°/32=123.75° (with reference to CN_{M}=0, corresponding to 0°) on the complete measuring standard 4 in FIG. 1, and the start position P_{S} on the trimmed measuring standard 4 in FIG. 2. The angular resolution is 360°/32=11.25°; the code number CN_{M}=16 corresponds to 180° on the measuring standard with the complete binary code 1.

The angular resolution of the trimmed measuring standard of FIG. 2 mapped onto the smaller measuring standard in FIG. 3a is 360°/26=13.85°. With CNₘ=0 (corresponding to 0°) CNₘ=1 here corresponds to the angle 13.85° and CNₘ=13 to the angle 180°.

The position markings 9 of the second binary code 2 can also be recorded by the sensor device 6, and then transmitted for further treatment to the further processing unit 8. The conversion of the code words C of the first binary code 1 and of the second binary code 2 into code positions P_{M} can then take place in the further processing unit 8, for example by means of a look-up table and/or other mathematical methods such as, for example, by means of a feedback shift register. The further processing unit 8 comprises a code converter 12 as a function block for this purpose. The code position P_{M} ascertained in each case in this way can then be processed by the further processing unit 8, and further signals can be generated from it. The further processing unit 8 can consist of digital and/or analogue function and circuit blocks 12, 13, 14, that are used in the same way for the different diameters of the measuring standard 4 and assigned code spaces. Measuring standard 4 with different diameters can thus, for example, be scanned and evaluated with a single hardware realization of the sensor device 6 and the further processing unit 8 as an integrated circuit. In position-measuring devices 3, incremental A/B signals can, for example, be generated as a measure for speed and direction of movement. The mapping of the second binary code 2 onto the first binary code 1 can take place in order to be able to use the same function blocks, i.e. in particular the function blocks of the code converter 12, the function block of the mapper 13, and downstream function blocks 14 as are used for the first binary code 1 for the processing of the second binary code 2.

The further processing unit 8 can, for example, have the following function blocks 14 that follow the code converter 12 and/or the mapper 13.

The further processing unit 8 here provides a block that generates incremental signals and/or commutation signals. The further processing unit 8 is furthermore designed as a counter that forms a multi-turn value. In particular, the further processing unit 8 provides an interface such as, for example, BiSS, SPI or the like.

As already described, the mapper 13 can also be integrated into the code converter 12 and/or into one or a plurality of function blocks 14 that follow the code converter 12.

The position-measuring device 3 according to the invention can be used both in measuring systems in which a continuous ascertainment of the position is performed by means of a measurement, and/or in counting systems 3.

With a position-measuring device according to the invention, an absolute position of a position-measuring device 3 can be generated in a simple manner. It is no longer necessary to provide different sensor devices 6 and further processing units 8 for position-measuring devices 3 for different radii of measuring standard 4. By mapping the second binary code 2 with a second number m of code words C onto the first binary code 1 with a first number M of code words C, each of which has a code word length L, the measuring standard 4 can be adjusted to the respective system 3, in particular with a smaller diameter, and the recorded signals thus processed without problems by an existing further processing unit 8. Advantageously the invention can therefore be employed, in particular, in rotary, optical or magnetic position-measuring devices 3, since with a single fixed sensor layout that is designed with L bits, and the sensor elements 7 of which have a fixed length corresponding to the length of the position markings 9, the code words C can be determined in a closed code. As a consequence of this, the respective length of the total code 1, 2, and thereby the diameter of the measuring standard 4, can also be determined. The scaling is done with fewer code words C and thereby smaller diameters of the measuring standard 4, proportional to m/M.

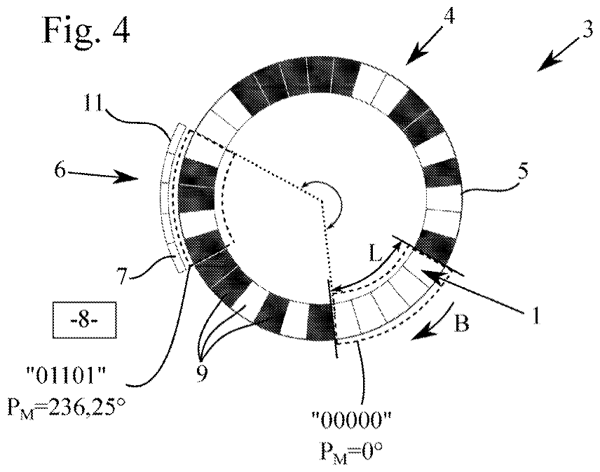

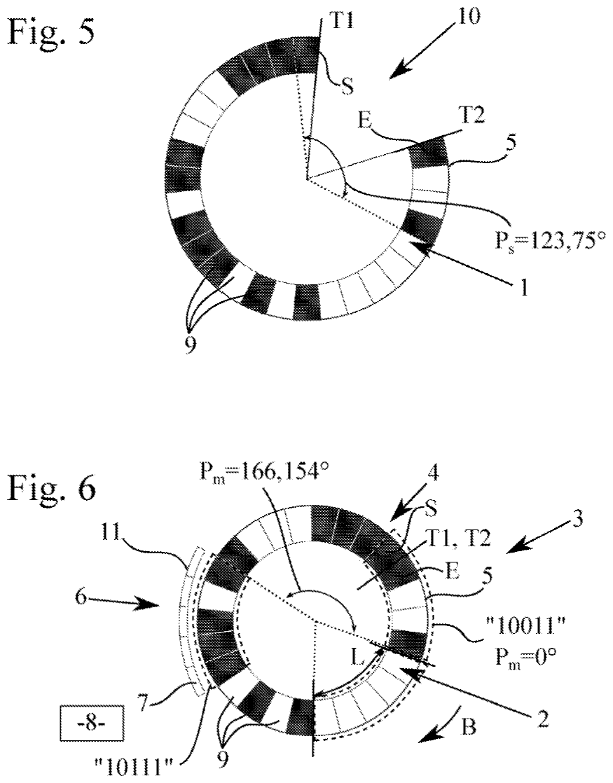

The flow of the measuring process with a position-measuring device according to the invention for ascertaining the rotary position of the measuring standard is described below in detail once again with reference to FIGS. 4 to 6. FIG. 4 corresponds to FIG. 1a, FIG. 5 corresponds to FIG. 2 and FIG. 6 corresponds to FIG. 3a, wherein position information have been added in each case by example.

The position-measuring device 3 comprises, according to FIG. 4, a measuring standard 4, a sensor device 6 and a further processing unit 8. A first binary code 1 is present on the measuring standard 4, which can be correspondingly scanned by the sensor device 6. The sensor device 6 is designed for sampling with code words C, and in the present example comprises five sensor elements 7. The sensor device 6 can be integrated onto a chip. A further processing unit 8 is connected to the sensor device 6. This can be integrated onto a common chip together with the sensor device 6.

The further processing unit 8 comprises a plurality of function blocks, namely a code converter 12 that performs the conversion of the code words into position information, a mapper 13 for taking the mapping relationship into account, and further function blocks 14. The function blocks 12, 13, 14 of the further processing unit can, although not necessarily, be designed as a separate unit. Individual, multiple or all the functions of the function blocks 12, 13, 14 can also be realized in a common unit, for example in a common integrated circuit.

For the sake of better understanding, a known measuring method is first explained:

In the exemplary embodiment, the code words C are stored in a table, illustrated in FIG. 1b, for shift code conversion. The code conversion is carried out by the code converter 12, in which the conversion of the table is implemented. Preferably the code conversion is realized by shift registers or using a stored look-up table. Other types of code conversion are, however, possible.

A corresponding code number CN_{M} is uniquely assigned to each code word C, and can be used for numbering the code words C. A number M=32 of code numbers CN_{M} result for the exemplary embodiment.

The sensor elements 7 of the sensor track 11 scan the binary code 1. In the position of the measuring standard 4 illustrated in FIG. 4, the code word C “01101” is correspondingly scanned, and, in accordance with the code conversion implemented according to FIG. 1b, corresponds to the CN_{M} value “21”. The corresponding position P_{M}, which in the exemplary embodiment corresponds to an angular position, is then ascertained, for example computationally, using this CN_{M} value. The formula given in FIG. 1b can be used for this purpose, according to which P_{M}=21×360°/32=236.25°. The scanned code word C “01101” thus corresponds to the position P_{M}=236.25° of the measuring standard 4. This procedure so far does not contain the realization of the invention.

It is now possible with the invention to achieve that with the same sensor device 6, other measuring standard can also be used, for example because a smaller measuring standard is needed due to the available space, or because only a lower resolution is necessary. The measuring standard 4 with the binary code 1 is therefore to be replaced, for the further explanation of the invention, by a measuring standard 4 with a smaller diameter according to FIG. 6.

The smaller measuring standard 4 according to FIG. 6 comprises a second binary code 2, which forms an in particular contiguous portion of the first binary code 1. The binary code 2 thus comprises a smaller number of code words C, namely m=26, and this number m of the position device 3 is to be specified when exchanging the measuring standard 4. The sensor device 6 and the further processing unit 8, together with the code converter 12 that carries out the code conversion, are retained, and are not exchanged.

If the sensor device 6 now scans the second binary code 2, then in the position of the measuring standard 4 illustrated in FIG. 6, the code word C “10111” will accordingly be scanned. With the unchanged, stored code conversion according to FIG. 1b, the scanned code word C “10111” corresponds to the value CN_{M} “23”. Using this value, a position P_{M} can be ascertained, analogously to the procedure described previously, according to which P_{M} (CN_{M}=23)=23×360°/32=258.75°.

Since the position P_{M} of the angular position corresponding to the code word C “10111” ascertained in this way corresponds, however, to the position on a larger measuring standard 4 according to FIG. 4 with the first binary code 1, the position P_{M} ascertained from the code conversion according to FIG. 1b still has to be mapped by the mapper 13 onto the actual position Pₘ.

In the present example, this is done by means of the mapping rule Pₘ=M/m (P_{M}−P_{S}). M/m here corresponds to a scaling factor that results from the different number of code words C, namely M=32 and m=26. The position P_{S} corresponds to the position displacement of the measuring standard 4 of FIG. 6 as compared with the measuring standard 4 of FIG. 4, since, due to the shortening of the code, a different alignment of the zero position of the smaller measuring standard has occurred.

The number M is known to the further processing unit 8. The mapper 13 can, for example, read M from the stored code conversion, or M can be stored directly as a numerical value in the mapper 13.

The start position P_{S} (FIG. 5) can, for example, be ascertained analogously to the ascertainment of the code position P_{M}, for example using P_{S}=S×360°/M. The start value S must accordingly be specified when exchanging the measuring standard for this purpose. It is, however, also possible to specify the end value E and/or the position displacement P_{S} directly.

For the exemplary embodiment illustrated in FIG. 6, a scaling factor of M/m=32/26=1.231 and a position of P_{S}=11×360°/32=123.75° (FIG. 5) thus results on the trimmed measuring standard. For mapping the position P_{M}=258.75° onto the position Pₘ it therefore follows that Pₘ=32/26×(258.75°−123.75°)=166.154°. This corresponds to the actual position that is to be ascertained of the shortened measuring standard 4 according to FIG. 6 related to the new zero position Pₘ=0° with the code “10011” corresponding to the code number CN_{M}=11 from the code table in FIG. 3b.

The mapper 13 is configured so that a cyclic overflow can be ascertained and taken into account. The binary codes 1, 2 of the exemplary embodiment is a closed code, so that to apply the mapping rule it is necessary, when forming the difference “P_{M}−P_{S}”, to bear in mind that this term must always be greater than or equal to “0”. In the event that the difference term is smaller than 0, an additional 360° must be added to it before the scaling. Were the sensor device 6 with the measuring standard 4 and with binary code 2 to scan, for example, the code word C “00001”, then it follows from the stored code conversion according to FIG. 1b that CN_{M}=1. With position P_{M}=11.25° the result for the difference term P_{M}−P_{S}=−112.5°, which is smaller than “0”. Due to the cyclically closed nature of the code, the position Pₘ=M/m (P_{M}−P_{S}+360°)=304.615° is therefore ascertained.

In the previously described exemplary embodiment, the positions P_{M} and Pₘ were given as angular positions. It is also possible to use other dimensions of the position. The position dimension used can, in particular, be matched to the function blocks 14 of the further processing unit 8. Other position dimensions can accordingly be used provided, for example, the further processing unit 8 does not require angle information. The position dimension can, for example, also be an incremental value. It is in particular possible that the position dimension has the format of the code number CN itself. An example is now to be presented for this case:

Analogously to the procedure described previously, the code word C “10111” is first scanned by the sensor device 6 on the measuring standard 4 according to FIG. 6, and corresponds, in the code conversion according to FIG. 1b, to the CN_{M} value “23”. Now, however, an angular dimension is not used as the dimension for the position P_{M}, but the format of CN_{M} itself, where the identifier P′M is used below as a real numerical value purely for the purpose of clarification. The CN_{M} value at this position thus corresponds to the position P′M of a measuring standard 4 according to FIG. 4 with the first binary code 1, and must still be mapped to the actual position.

The mapping takes place in the same way in the mapper 13 through the mapping rule P′ₘ=M/m (P′_{M}−P′_{S}) already explained, wherein the position P′ expressed as the CN value is again here scaled and displaced. While the scaling factor M/m results from the different numbers M, m of code numbers CN, the displacement P′_{S} corresponds to the start value S. The start value S can be specified directly. It is equally possible to specify the end value E and to ascertain the start value S from the difference between the numbers M and m.

For the CN_{M} value “23” assigned to the code word C “10111”, a position value of P′ₘ=32/26×(23−11)=14.77 thus results. This corresponds to the actual position of the measuring standard 4 according to FIG. 6 that is to be ascertained, while the format of the code numbers itself is chosen as the position dimension. This value P′ₘ can be processed by the further processing unit 8, in particular by the function blocks 14.

The example makes it clear that the mapping can be independent of the dimension of the position information P. Yet more position dimensions could accordingly be used. The position dimensions are advantageously chosen such that they can be processed by the further processing unit 8.

The same sensor device 6 can, of course, also be employed for further measuring standard 4 with an arbitrary number m≤M of code words. The respective design of the measuring standard 4 is taken into account in the mapper 13, for which purpose only a few parameters of the measuring standard 4 that is to be used have to be specified to the mapper 13, in particular the parameters m and P_{S}, or other information from which these parameters can be ascertained, such as, for example, S and E.

The further processing unit 8, with the implemented mapper 13, also of course functions with the measuring standard 4 of FIG. 4, where in this case M=m, Pₛ=0 and therefore Pₘ=P_{M}.

The position device 3 according to the invention, through the specified, fixed and unique mapping relationship between the first binary code and the second binary code 2, or between the positions P_{M} and Pₘ, thus enables the use of different measuring standard 4 with different binary codes 1, 2 while retaining the hardware in use, such as, in particular, the sensor device 6 and the further processing unit 8, and in particular the code conversion implemented once, so that cumbersome and expensive refitting of the position-measuring device 3 is not required.

The design of the measuring standard 4 is selected according to the invention in such a way that the second binary code 2 is mapped onto the first binary code 1. The mapping relationship is fixed and unique, so that this mapping relationship can be used to ascertain the position that is to be measured.

### REFERENCE SIGNS

1 First binary code
2 Second binary code
3 Position-measuring device
4 Measuring standard
5 Position track
6 Sensor device
7 Sensor elements
8 Further processing unit
9 Position markings
10 Portion
11 Sensor track
12 Code converter
13 Mapper
14 Function blocks
M First number of code words
m Second number of code words
C Code words
L Code word length
CN_{M} Code number in the first code table
CNₘ Code number in the second code table
S Start value of the code
E End value of the code
P_{M} Code position in the first binary code
Pₘ Code position in the second binary code
P_{S} Start position
B Direction of movement
T1, T2 Separation point
V Mapping rule

1. A position-measuring device for measuring an absolute position, the position-measuring device comprising:
a measuring standard that has a binary code and a sensor device that scans the binary code, wherein the binary code includes a first binary code having a first number of code words that have the same code word length and the sensor device scans the first binary code; and
wherein the binary code includes a second binary code that forms a portion of the first binary code, the second binary code having a second number of code words that can be mapped onto the first binary code.

2. The position-measuring device as claimed in claim 1, wherein the second binary code can be mapped onto the first binary code by a predefined mapping rule.

3. The position-measuring device as claimed in claim 1, wherein the first and the second binary codes comprise unique code words, each of which is assigned to a unique code position with the code word length over which the first and the second binary codes extend.

4. The position-measuring device as claimed in claim 3, wherein the code positions of the second binary code can be mapped onto the code positions of the first binary code by a mapping rule.

5. The position-measuring device as claimed in claim 4, wherein the mapping takes place taking a scaling factor and/or a position displacement into account.

6. The position-measuring device as claimed in claim 5, wherein the scaling factor establishes the relationship between the first number of code words and the second number of code words.

7. The position-measuring device as claimed in claim 3, wherein the code words of the second binary code have the same sequence as the code words of the first binary code, in particular in the portion of the first binary code.

8. The position-measuring device as claimed in claim 1, further comprising a further processing unit for processing the scanned sensor signals and/or for converting the code words into code positions.

9. The position-measuring device as claimed in claim 3, wherein the conversion of the code words into the code positions takes place by means of a look-up table and/or by means of a feedback shift register.

10. The position-measuring device as claimed in claim 1, wherein the first binary code with the first number of code words having the same code word length is a complete code in which all possible M=2^{L} bit combinations occur.

11. The position-measuring device as claimed in claim 1, wherein the first binary code and/or the second binary code is a closed code in which, on exceeding a last code position of a last one of the code words in a first code position, again follows.

12. The position-measuring device as claimed in claim 1, wherein the measuring standard is a rotary measuring standard, in particular as a circular disk or roller.

13. The position-measuring device as claimed in claim 8, wherein for mapping the second binary code onto the first binary code, unique code positions are predefined through a start value and an end value of the second binary code within the first binary code, or through the second number of code words and the start value, or the end value of the second binary code within the first binary code in the further processing unit.

14. The position-measuring device as claimed in claim 3, wherein the second binary code has a start position that can be subtracted from a respective one of the code positions of the measuring standard to map the second binary code onto the first binary code.

15. The position-measuring device as claimed in claim 1, wherein the sensor device comprises at least a variety of sensor elements, so that the total code word length of a code word can be captured simultaneously or in sequence.

16. The position-measuring device as claimed in claim 1, wherein the position-measuring device is designed as a measuring or counting position-measuring device.

17. A method for measuring an absolute position, the method comprising:
providing a position-measuring device for measuring an absolute position with a measuring standard that has a binary code; and
scanning the binary code with a sensor device, wherein the sensor device scans a first binary code that has a first number of code words that have the same code word length, wherein the binary code of the measuring standard is a binary code that forms a portion of the first binary code with a second number of code words that are mapped onto the first binary code.

18. The method as claimed in claim 17, further comprising selecting the binary codes to have unique code words; assigning each of the code words to a unique code position with a code word length over which the binary codes extend; and mapping the code positions of the second binary code onto the code positions of the first binary code by means of a mapping rule.

19. The method as claimed in claim 18, wherein the mapping takes a scaling factor and/or a position displacement into account.

20. The method as claimed in claim 19, wherein the scaling factor establishes a relationship between the first number of code words and the second number of code words.
